(19) United States
(12) Patent Application Publication
(10) Pub. No.: US 2011/0010297 A1
(43) Pub. Date: Jan. 13, 2011

(54) Computer-Implemented Method and System for Controlling Third Party Access to Personal Content and Computer-Readable Storage Medium Employed Therein

(76) Inventor: Divesh Sisodraker, Vancouver (CA)

Correspondence Address: Valuetech c/o John R. Flanagan, 601 Country Club Road, Apt. 1085, P.O. Box 2629, Eugene, OR, 97402, US

(21) Appl. No.: 12/832,982

(22) Filed: Jul. 8, 2010

Related U.S. Application Data
(60) Provisional application No. 61/270,746, filed on Jul. 13, 2009.

(51) Int. Cl. G06F 21/00; H04L 9/32; G06F 15/16

(52) U.S. Cl. 705/52; 726/6; 709/206

(57) ABSTRACT

A computer-implemented system and method for controlling third party access to personal content includes accepting different versions of personal content, displaying a public version of the content, prompting for a passcode and then displaying a private version of the content that is dependent on the passcode.

This patent application claims the benefit of U.S. provisional application No. 61/270,746 filed Jul. 13, 2009. The disclosure of the provisional application is hereby incorporated herein by reference.

### BACKGROUND

1. Field of the Invention

The present document relates to the controlled provision of personal content via a network of computing and communication devices. More specifically, it relates to a computer-implemented method and system for controlling third party access to personal content and a computer-readable storage medium employed therein.

2. Description of Related Art

Many jobseekers publish their resumes online, either directly or via recruitment sites, making them widely available to multiple potential employers. Jobseekers also have the ability to publish different versions of their resumes.

When a resume is uploaded to the recruitment web site Monster, there are three choices. “Private” means that a resume will not be seen by employers conducting resume searches. However, a private resume can be used to apply for jobs. If the resume status of “Public” is selected, employers will be able to find the resume and match the jobseeker to specific jobs. If “Confidential” is selected, employers will not see the jobseeker's name, contact information, current employer or references. There is the option to prevent up to twenty companies from seeing one's public resume on Monster. Monster does not track who views resumes, only the number of times a resume view is requested.

It is possible to post up to ten resumes on Workopolis. If it is preferred that a resume is not seen by employers then a resume can be made available only to companies applied to. The resume will then be hidden and only seen by others if one chooses to send it when applying for a job online.

The site iResume offers a resume publishing and tracking service where multiple resumes are distinguished only by a different URL and are potentially available to be viewed by anyone. One can track views for each URL, but cannot tie these views back to anyone in particular.

Resumes made using VisualCV can be shared with different privacy levels. They can be sent via e-mail to one person, shared on social networks or posted to a URL. Like iResume, different CV's can have different links. A new CV can be made by copying an existing one and tweaking it as needed.

LinkedIn allows public versions of career related profiles to be viewed online. LinkedIn requires an account to see full profiles. Therefore, a username and password is required to get into LinkedIn in order to see a full profile, but a further password is not needed to look at someone else's profile once one is logged in. With an upgraded account, LinkedIn lets a user see who has looked at his profile, but not how often.

U.S. Pat. No. 6,853,982 discloses a method for content personalization based on actions performed during a current browsing session. A monitoring component of a merchant's web site maintains a record of products viewed by each user during a current browsing session. A recommendations component uses the resulting history of viewed products to identify additional products to recommend.

U.S. Pat. No. 7,359,894 discloses methods and systems for requesting and providing information in a social network. An information request allows a user to request information from at least one member of a social network associated with the user and the system automatically identifies one or more members of the social network to send the request to based on stored member data.

US Patent Application Publication No. 20080040370 discloses systems and methods for generating dynamic, relationship-based content, personalized for members of a web-based social network. As members may be inundated with voluminous information that does not interest them, this enables members to find in a timely and efficient manner the information that does interest them.

While currently available systems permit widespread viewing of resumes, it would be useful for jobseekers to retain more control over their resumes, to know who is viewing their resumes and to be able to efficiently tailor their resumes depending on who is viewing them. Likewise, people other than jobseekers, such as actors/models and other artists, individual contractors, or other professionals generally would find it useful to provide summary profiles that are widely and publicly available, but retain the ability to control and tailor more complete profiles according to different viewers.

### SUMMARY

The invention described herein is directed to a computer-implemented method and system for controlling third party access to personal content that allows providers/owners of personal content to enter introductory profiles, in other words, public versions of personal content provided by the owners, via a network such that they are publicly available. A requestor of a profile, for example an employer, has the ability to request to receive more of the profile (if they do not already have a passcode to see the full profile), in other words, a private version of personal content provided by an owner, or the option to enter a customized passcode to be able to receive more of the profile, the content of the additional portion of the profile that is provided being associated with the customized passcode. When a request for more of a profile is received by the owner of the profile, the owner can select which additional private version of the profile to provide to the requestor, and provide the requestor with a passcode that enables receiving the specific version selected. With the knowledge of which requestors have which passcodes, there is the ability to track who received each version of the private profile, when they received it and how often. Moreover, it is possible to associate different passcodes with different requestors but for the same version of a profile. This provides insight into who received a profile without having to create multiple versions of the same profile for tracking purposes.

Control of who receives the content of the profile is with the content provider, the owner, and not the requestor or employer. The disclosed system and method provide one or more of the following advantages: the ability to use an online public profile at a single URL as a gateway to a customized private profile; the ability to protect access to a private profile using passcodes; the ability to assign content to a private profile based on passcodes; the ability to dynamically generate a private profile tailored to the requestor based on a passcode entered (thereby displaying multiple profiles at a single URL); the ability to track who received each version of the private profile (including the ability to track different parties with access to the same private profile using different passcodes), and when and how often each was received based on passcodes used; and the ability to update a section of a profile that is common to multiple versions of private profiles.

### BRIEF DESCRIPTION OF THE DRAWINGS

FIG. 1 is a general diagram of the basic relationship underlying the present invention between personal content providers, personal content users, an online personal content manager and a network interconnecting them.

FIG. 2 is a schematic illustration of an exemplary hardware arrangement suitable for practicing the method and system of the present invention.

FIG. 3 is a flowchart showing how the system allows the setting up of profiles.

FIG. 4 is a flowchart showing how the system displays detailed profiles.

FIG. 5 is a screenshot of a public profile.

FIG. 6 is a partial screenshot showing methods of access to a detailed profile.

FIG. 7 is a screenshot of a jobseekers home page.

FIG. 8 is a screenshot of a Master CV Edit page.

FIG. 9 is a screenshot of Custom CV links.

FIG. 10 is a screenshot of statistics.

FIG. 11 is a screenshot of a custom CV build.

FIG. 12 is a screenshot of a detailed CV.

FIG. 13 is a screenshot of a detailed CV.

### DETAILED DESCRIPTION

The following detailed description includes references to the accompanying drawings, which form a part of the detailed description. The drawings show, by way of illustration, specific embodiments in which the machine and methods may be practiced. These embodiments, which are also referred to herein as “examples” or “options,” are described in enough detail to enable those skilled in the art to practice the present invention. The embodiments may be combined, other embodiments may be utilized or structural or logical changes may be made without departing from the scope of the invention.

In this document, the terms “a” or “an” are used to include one or more than one, and the term “or” is used to refer to a nonexclusive “or” unless otherwise indicated. In addition, it is to be understood that the phraseology or terminology employed herein, and not otherwise defined, is for the purpose of description only and not of limitation.

The words “resume” and “CV” are used interchangeably. The detailed description relates mainly to the management of resume versions, although it is understood that the principles disclosed herein can equally well be applied to other types of profile or personal content.

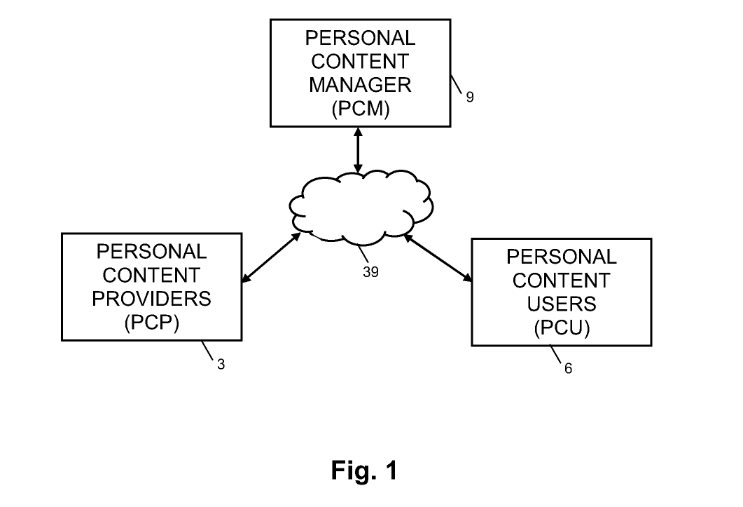

FIG. 1 shows a general diagram of the basic relationship underlying the present invention between one or more personal content owner or providers (PCP) 3, such as job seekers; one or more personal content users (PCU) 6, such as employers or requestor; an online personal content manager (PCM) 9, such as incorporated by an Internet website or the like; and a network 39, such as the Internet or other telecommunications network. The online PCM 9 is configured as a computer readable medium carrying computer-readable instructions that, when processed by its processor in accordance with the method and system of the present invention, accepts different versions of personal content inputted by one PCP 3, displays a publicly-available version of the personal content when requested by one or more of the PCUs 6, prompts for a passcode assigned to a given one of the PCUs 6 when a private version of the personal content is requested, and displays to the given one of the PCUs 6 a private version of the personal content associated with the passcode. The PCM 9 in such manner allows provision of a publicly available first portion of personal content followed by the restricted provision of a second portion of personal content that is tailored by the personal content provider PCP 3, according to the recipient PCU 6.

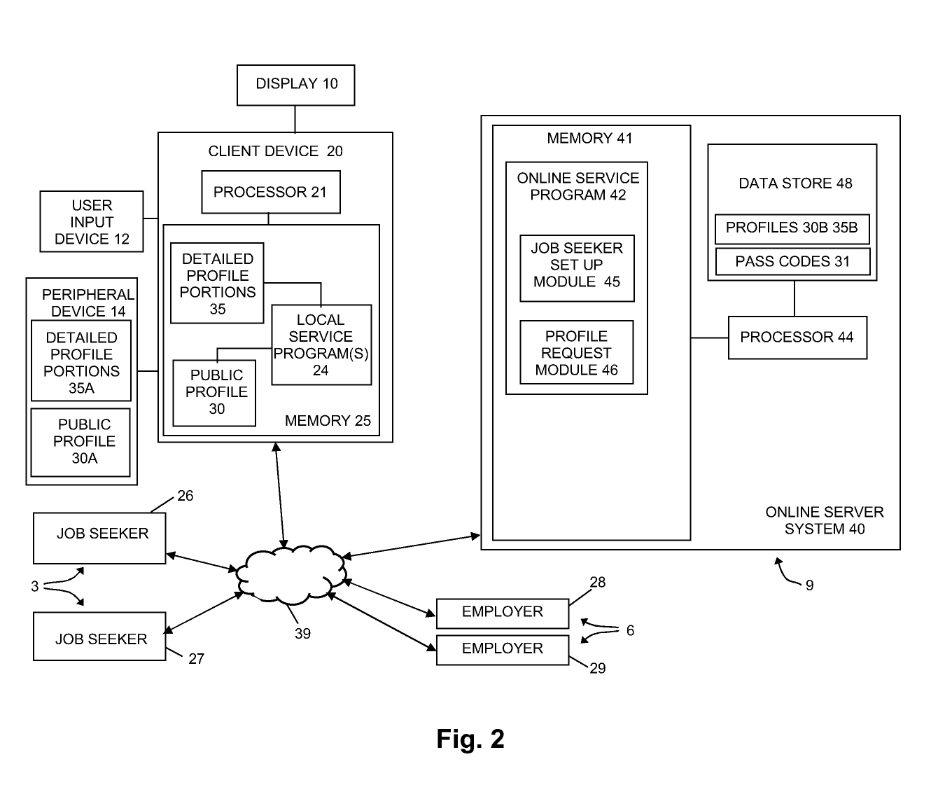

FIG. 2 shows hardware arrangement suitable for practicing the computer-implemented method and system of the present invention for controlling third party access to different versions of personal content. The online PCM 9 may take the form of a server 40 that comprises a processor 44 and computer readable memory 41. The memory 41 has within it computer readable instructions in online service program 42. Within the program 42 there are two main modules, which are a job seeker set-up module 45 and a profile request module 46. The set-up module 45 permits a jobseeker (a PCP 3) to set up a public profile and multiple private profiles which can be passcode protected and only supplied with the profile owner's permission to other people, PCUs 6 such as employers 28, 29. The profile request module 46 manages requests from other people who wish to view or receive a profile owner's private, or more detailed resume. The modules may be further divided, or additional modules may be included to provide the same functions in an alternate way.

The server 40 is connected via the network 39, which could be the internet, a telecommunications network or a combination of both, to a client device 20, which may be a desktop computer, a laptop, a netbook, a PDA, a smart phone, an iPad™ or any other such computer-interfaced device, or suitable electronic computing or communications device. Device 20 may be connected to display 10 and/or user input device 12, or these components may incorporated within the client device 20. The client device 20 typically includes a processor 21 that can process computer readable instructions present in memory 25. These instructions may form local service program(s) 24 such as a web browser application. Also within memory 25, which may be divided into different types of memory or separate memory components, a job seeker's public profile 30 and private profile portions 35 may optionally be stored.

An additional peripheral device 14, such as a memory stick, may also be configured to store copies of the public profile 30A and private or detailed profiles 35A.

Multiple jobseekers 26, 27 using devices similar to client device 20 can connect via the network 39 to the server 40. Multiple employers 28, 29 can also connect to the server 40 via the network 39, also using devices similar to those used as client devices 20.

The server 40 has within it or has access to a data store 48 that contains copies of profiles 30B, 35B for multiple jobseekers. When a request is made by an employer to view a public profile 30B the processor, following instructions in memory 41, retrieves the requested public profile 30B from data store 48 and displays it on the display 10 of the client device 20 of employer 28 or 29. When a request is made by an employer to view a private detailed profile 35B the processor 44, following instructions in memory 41, retrieves from data store 48 the requested private profile 35B that is associated with a passcode 31 that matches a passcode supplied by the employer and displays it on the display 10 of the employer's client device 20.

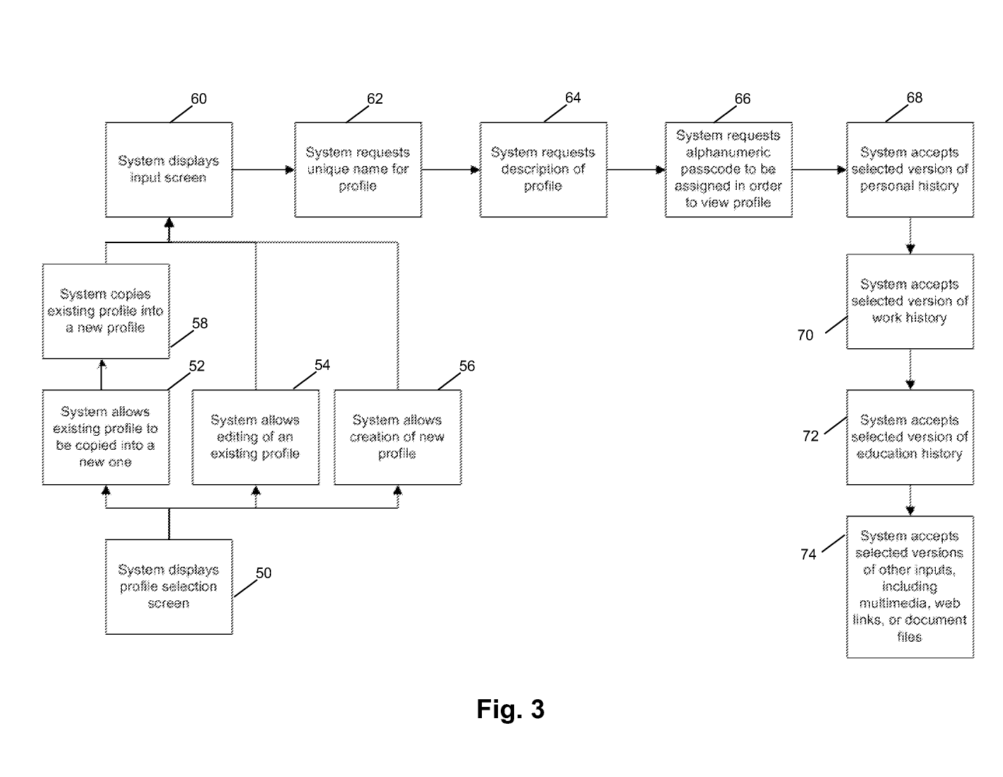

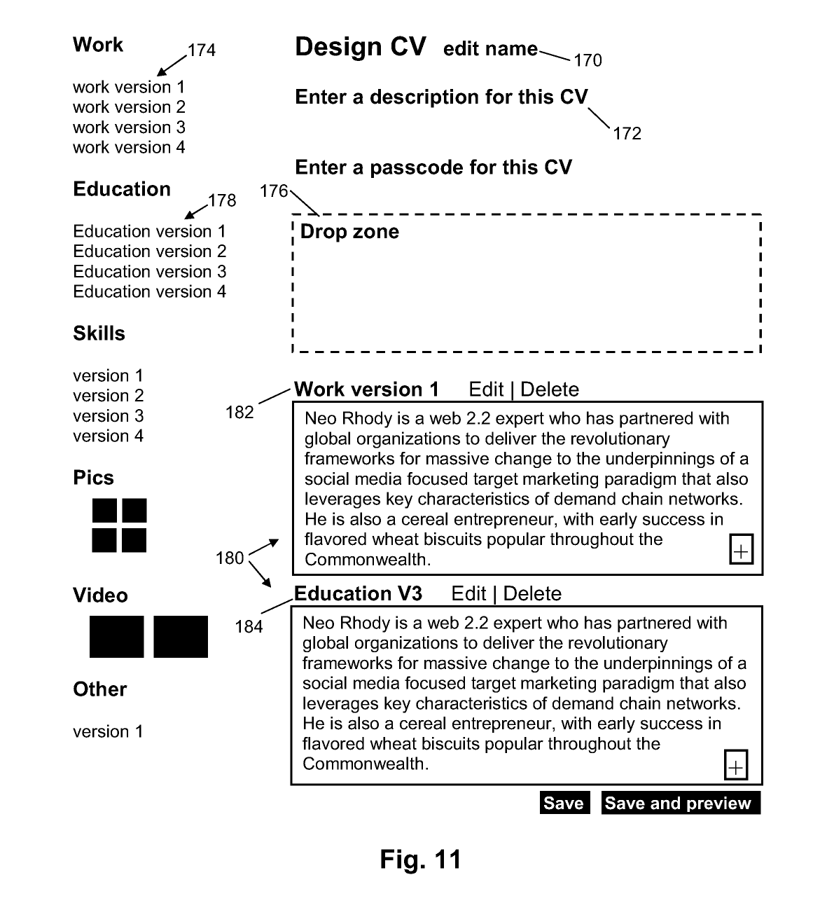

FIG. 3 shows the process by which the disclosed system guides a jobseeker 26 or 27 (hereinafter called “provider”) through the steps of setting up private, or more detailed profiles. A screen shot of part of this process is shown in FIG. 11. At the start, after a provider has performed any necessary log on or subscription steps and/or passed through a home page, the system displays a profile selection screen in step 50 on the display 10 of provider's client device 20. The provider may be presented with three choices: in step 56 creation of a new profile; in step 54 editing an existing profile; or in step 52 copying an existing profile into a new one. If the provider by step 52 selects to copy an existing profile to a new one, the system in step 58 performs this depending on the existing profile selected by the provider.

Once the choice of method for creating a profile has been determined, the system in step 60 displays an input screen, on which the system in step 62 prompts for a unique name to be given to the new profile that is to be created. The system in step 64 then prompts for a description to be given to the new profile. Following this, the system in step 66 prompts for a passcode to be assigned to the profile. The code may be numeric, letter, alphanumeric, or may contain special characters. Note that the prompts may all be requested on the same webpage, they may appear on different pages, or they may occur in a different order than described above.

Continuing with the creation of a new profile, the system in step 68 prompts and accepts an input of a provider-selected version of personal history. This may be a pre-existing version of personal history that the provider has already uploaded to or entered in the system, or it may be one that the provider creates during the new profile creation. In a similar way, the system in step 70 then prompts for and accepts an input of or selection of a version of a work history. Again in a similar way, the system in step 72 then prompts for and accepts an input of or selection of a version of an education history. The system in step 74 optionally accepts selection of or inputs of versions of other sections of the profile. These other sections may be multimedia files, web links or document files, for example.

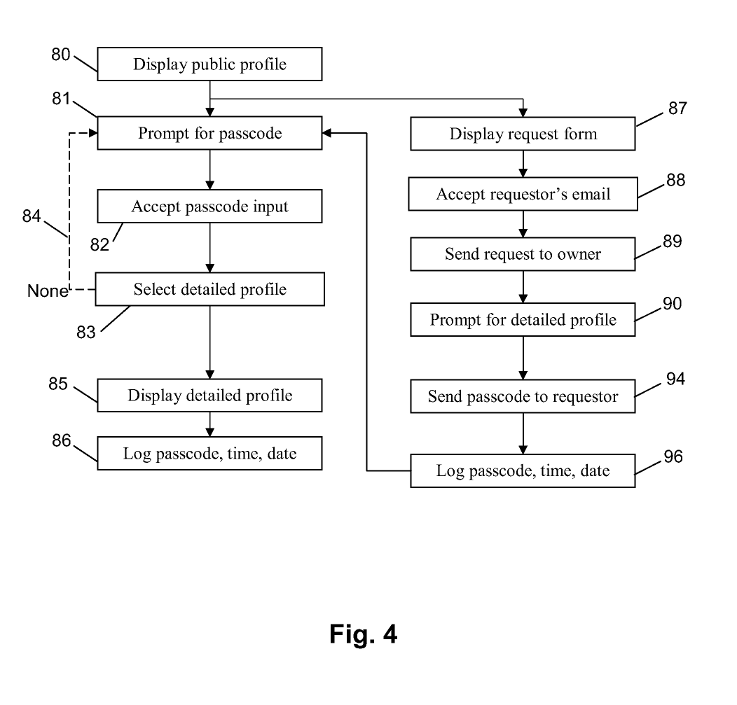

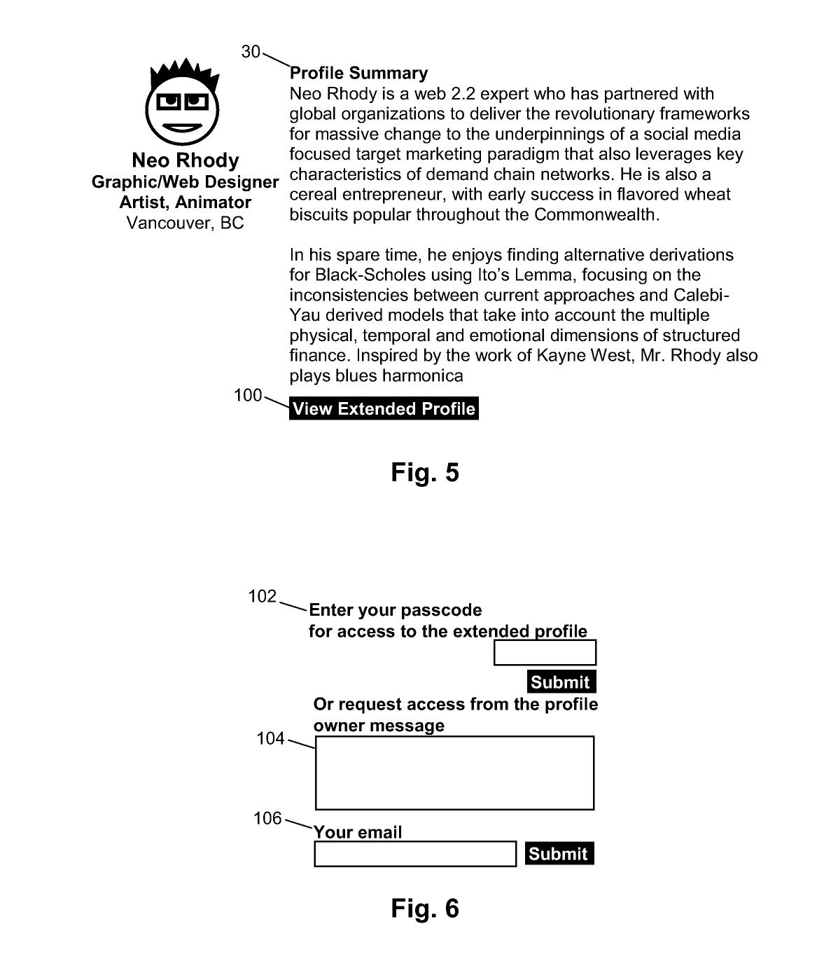

FIG. 4 shows the process the system goes through to enable an employer (hereinafter called “requestor”) to view a provider's private or detailed profile 35 (FIG. 2). In step 80, the requestor browses to a web page that displays the provider's public profile 30 (FIG. 2). The public profile 30 contains a brief introduction to the provider, and an example of such a public profile 30 is shown in FIG. 5. On the public profile page, a button 100 can be displayed indicating that an extended profile can be viewed. Continuing with FIG. 4, after the requestor clicks the “View Extended Profile” button 100 shown in FIG. 5, the system in step 81 displays a prompt 102 for a passcode, an example of which can be seen in FIG. 6. If the requestor has a passcode, the system in step 82 accepts entry of it and then in step 83 selects the private profile 35 which corresponds to the passcode supplied. If there is no corresponding private profile, the system as per arrow 84 can prompt again for the passcode. When the private profile 35 has been found, the system in step 85 displays the private profile 35 on the requestor/employer's client device 20. The system can also be configured to log, in step 86, the date, time and passcode used so that the provider at a later time can then access records of when each private profile has been viewed. If a user gives a unique passcode to each requestor, then the provider can track exactly who has viewed a private profile.

If the requestor clicks the “View Extended Profile” button 100, as seen in FIG. 5, the system in step 87 displays a form 104, as seen in FIG. 6, that can be used to request access to the extended profile by requestors who do not have a passcode. The system in step 88 accepts input of the request and/or the requestor's email 106 or other identification and then in step 89 transmits the request to the provider of the profile. The system in step 90 prompts the provider to select the detailed or private profile that should be supplied to the requestor, and then in step 94 sends the passcode that is associated with the private profile to the requestor that has made the request. The system in step 96 may them log the time, date, profile version and requestor in a database for future access by the provider. The system, on providing the passcode to the requestor, can then provide a link to the requestor to the public profile web page where entry of the passcode is prompted in step 81. Alternately, the private profile may be emailed directly to the requestor. A provider may compile a new version of the private profile before sending a passcode related to it to the requestor making the request.

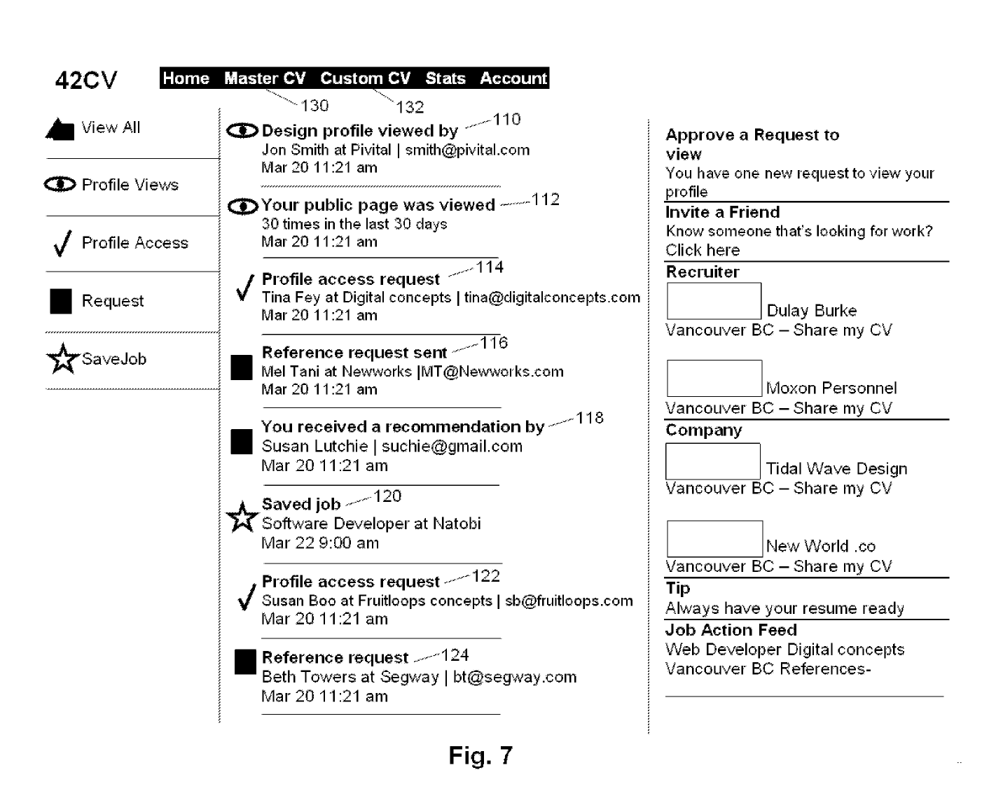

FIG. 7 shows an example home page for a jobseeker. There may be sections such as: Design Profile Viewed By 110, containing information such as Jon Smith at Pivital, Jon's email address, March 20 11:21 am; Your Public Page Was Viewed 112, containing information such as 30 times in the last 30 days, March 20 11:21 am; Profile Access Request 114, containing information such as Tina Fey at Digital concepts, Tina's email address, March 20 11:21 am; Reference Request Sent 116, containing information such as Mel Tani at Newworks Mel's email address, March 20 11:21 am; You Received A Recommendation By 118, containing information such as Susan Lutchie, her email address, March 20 11:21 am; Saved Job 120, containing information such as Software Developer at Natobi, March 22 9:00 am; Profile Access Request 122, containing information such as Susan Boo at Fruitloops concepts Susan's email address, March 20 11:21 am; and/or Reference Request 124, containing information such as Beth Towers at Segway, Beth's email address, March 20 11:21 am. Links such as “Master CV” 130 and “Custom CV” 132 lead to pages which allow a user to create and/or edit versions of resumes.

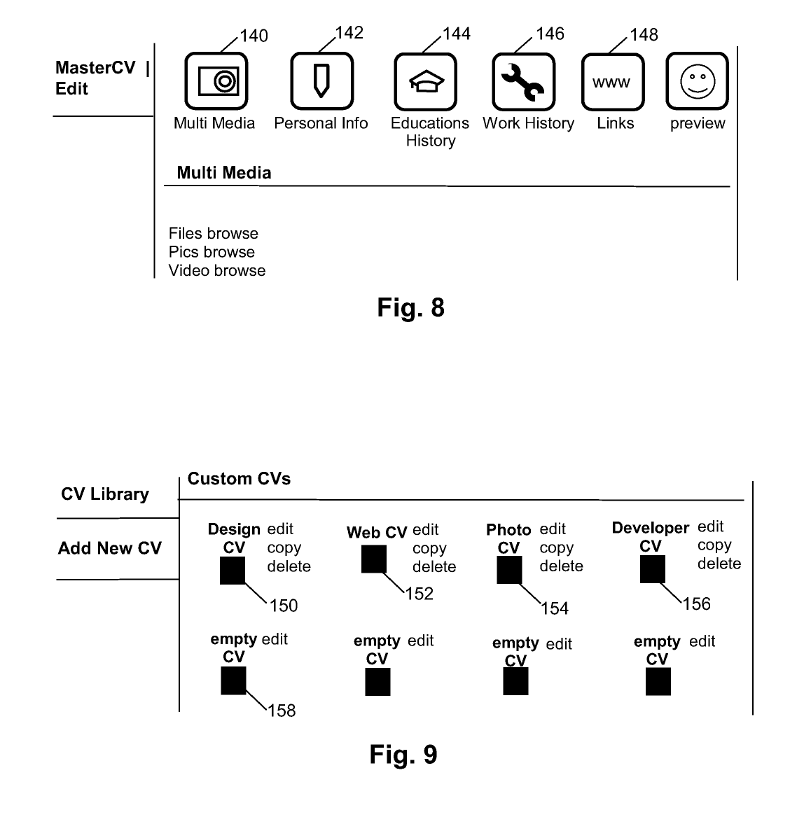

FIG. 8 shows some of the links that are possible on the Master CV Edit page. These allow the provider to enter multimedia 140, personal information 142, education history 144, work history 146 and links 148, for example.

FIG. 9 shows a screen shot with icons representing customized CV's. For example, shown is a Design CV 150, a Web CV 152, a Photo CV 154 and a Developer CV 156. There are also icons that represent empty CV's 158 that are available for the provider to compile at a future time.

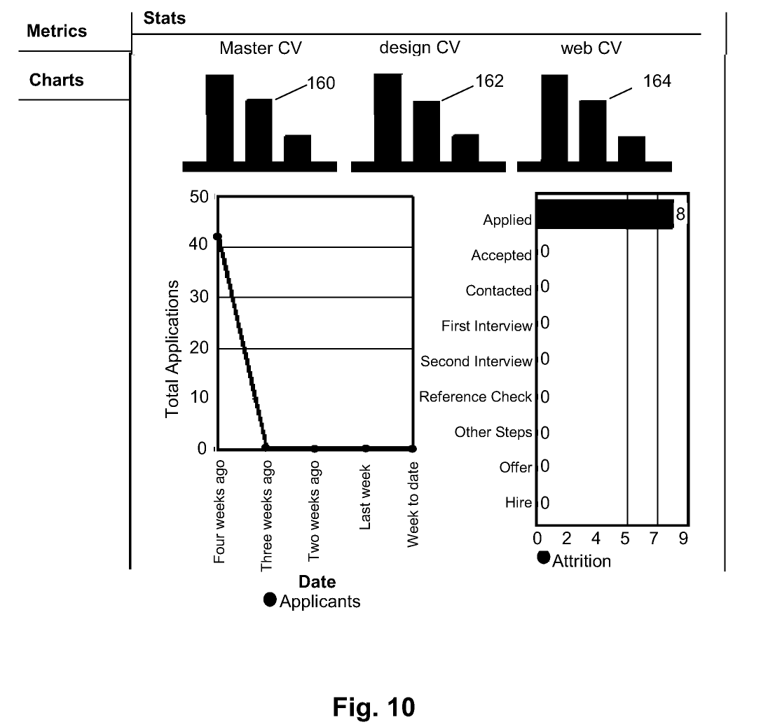

FIG. 10 shows example details of statistics—for example, the number of times 160 the master CV has been viewed in whole or in part, and/or the number of times 162, 164 each private CV profile has been viewed. This page can also help management of the job seeking process, by allowing the provider to monitor the number of requestors/employers that have made contact and/or the number of times an employer has returned to a profile, thereby indicating level of interest in a job seeker.

FIG. 11 shows an example of a web page that guides the provider through the creation of a new profile. It shows areas where a provider can enter a name 170 for a CV and a description 172 for a CV. On the left is a panel that lists, at the top, a series of four work history versions 174. Any one of these can be dragged over to the drop zone 176 to become part of the CV that is currently being compiled. Likewise, any of the four employment history versions 178 can be selected for inclusion in the CV. The same applies for the versions of the skills section of the CV, and likewise for other sections. The versions of each section that are selected appear in full in the compilation zone 180. In this example, “Work version 1” 182 has been selected as the work history version, and “Education V3” 184 has been selected as the version of education history.

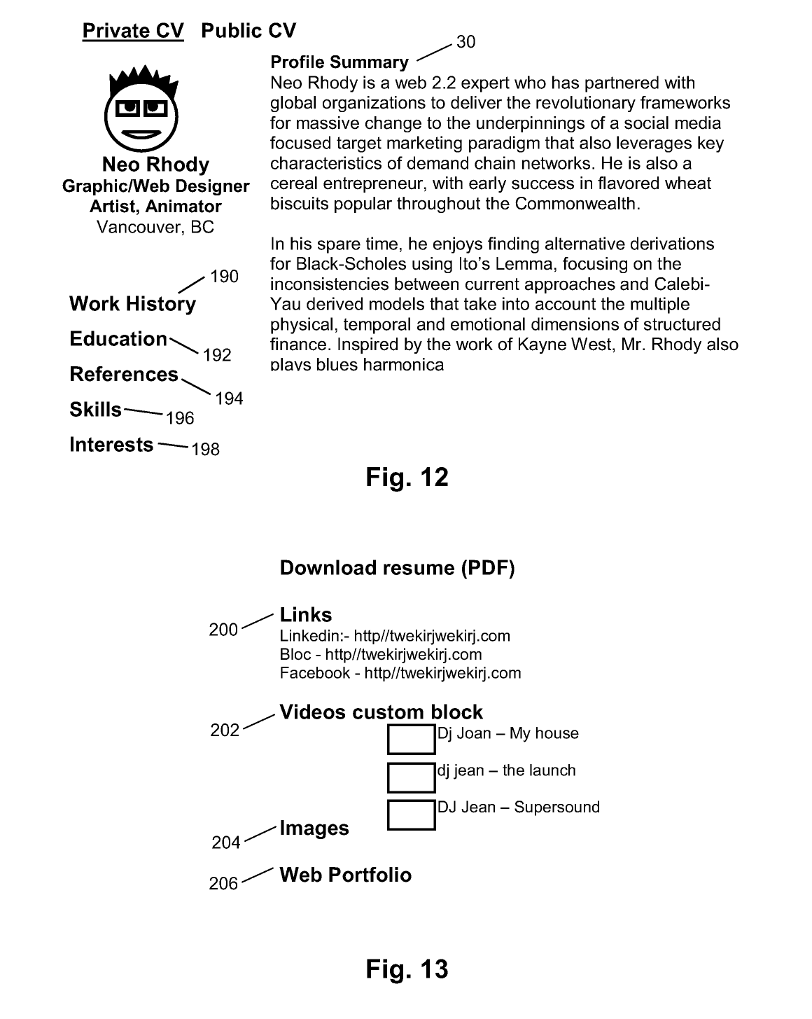

FIG. 12 shows an example of a private, or more detailed CV, that may be displayed on the screen of an employer's or requestor's electronic device. The public profile 30 is shown, followed by private sections such as Work History 190, Education 192, References 194, Skills 196 and Interests 198. Each one of these can be expanded to show the detail. As shown in FIG. 13, the private profile can also include sections such as Links 200, Videos 202, Images 204, Web Portfolio 206 and/or any other provider defined section.

The system allows providers to update a section of a resume that is included in multiple versions. The same resume can be assigned different passcodes, where each passcode is given to a unique employer. Employers may go through an authentication process, and the profile provider or owner may be informed whether a requestor is authenticated or not, and may have the option not to forward a passcode to an unauthenticated requestor. Providers/owners and/or requestors/employers may be charged a fee for the use of the system, which may be a per view charge, a monthly charge, and annual charge, a maintenance charge, or any other type of fee. Certain requestors may be provided with a master passcode, and providers may assign a version of their resume to such a passcode, without knowing what the passcode is, by giving permission to such a requestor for a specific resume version. Various security measures may be used in operating the disclosed system and in maintaining databases of private personal content.

It is also possible to configure the system so that a provider can identify a particular resume for mobile-initiated distribution. In this configuration, a provider sends the system a text message (or SMS) from a mobile communications device, such as a cell phone, a satellite phone or a smart phone, which may be in the form “send <email address>” or “send <faxnumber>”, for example. If the command is to send via email, then the system sends an email to <email address> with a unique passcode that is tied back to the recipient of the text message and the particular version of the resume already identified in the system. If the command is to send via fax, the system sends a fax of the resume identified to the fax number (and the fax may include a link and unique passcode to allow the recipient to view the profile online). A passcode could be pre-assigned to the resume, or on receipt of an SMS (Short Message Service) message, the system can be configured to automatically generate a recipient-specific passcode for the identified resume. More than one resume can be identified to be distributed this way, and could make use of an SMS message such as “send <CV#><email address>”

The system may be used for personal content other than resumes, such as profiles on social networking sites and any other type of personal content. Personal content may include resumes that are made available through social networking sites. The system may be used for personal profiles on dating sites, marriage sites, meeting sites and other introduction sites.

The steps described may be performed in a different order to that described herein, some may be added and others may be omitted while still providing the same core functions of the system. Other embodiments or variations of embodiments described can also be used to provide the same functions as described herein, without departing from the scope of the invention.

1. A computer-implemented method for controlling third party access to personal content, said method comprising the steps of:
accepting by a computer-readable memory different versions of personal content from a provider about the provider, said different versions including at least a public version and a private version;
receiving by a processor an assignation by the provider of a passcode to the private version;
communicating by a computer-interfaced device said public version of the personal content from said computer-readable memory to a requestor in response to a request by the requestor to receive said public version;
in response to a request by the requestor to receive said private version, providing by the processor a prompt to the requestor to enter the passcode; and
communicating by a computer-interfaced device to the requestor said private version of the personal content associated with said passcode.

2. The computer-implemented method of claim 1 further comprising, in response to the request by the requestor to receive said private version:
providing a prompt to the requestor to submit identification;
providing the identification to the provider;
receiving from the provider an input indicating that said passcode may be sent to the requestor; and
communicating via a computer-interfaced device said password to the requestor.

3. The computer-implemented method of claim 1 wherein said passcode is unknown to the provider.

4. The computer-implemented method of claim 1 further comprising charging a fee to the provider or the requestor or both the provider and the requestor.

5. The computer-implemented method of claim 1 further comprising:
providing by said processor instructions to the provider in setting up said public and private versions of personal content.

6. The computer-implemented method of claim 1 wherein said different versions accepted by the computer-readable memory further include different private versions tailored to different requestors.

7. The computer-implemented method of claim 6 further comprising:
providing by said processor instructions to the provider in setting up said public and private versions of personal content.

8. The computer-implemented method of claim 6 wherein plural passcodes are accepted by the processor associated with each of the different private versions.

9. The computer-implemented method of claim 1 wherein said communicating by the computer-interfaced device includes sending said public and private versions to the requestor via a display.

10. The computer-implemented method of claim 1 wherein said communicating by the computer-interfaced device includes sending said public and private versions to the requestor by fax.

11. The computer-implemented method of claim 1 wherein said communicating by the computer-interfaced device includes sending said public and private versions to the requestor by email.

12. The computer-implemented method of claim 1 where one or more of the steps are performed by a social networking site.

13. One or more computer-readable storage media carrying computer-readable instructions that, when processed by a processor, configure a system to perform said computer-implemented method of claim 1.

14. One or more computer-readable storage media according to claim 13 carrying computer-readable instructions that, when processed by a processor, configure a system to perform the computer-implemented steps of claim 2.

15. A computer-implemented system programmed to control third party access to personal content, said system comprising:
a computer-readable memory adapted to accept different versions of personal content from a provider about the provider, said different versions including at least a public version and a private version;
a computer-interfaced device adapted to communicate said public and private versions of the personal content in response to a request by a requestor to receive said public and private versions; and
a processor adapted to provide a passcode to the requestor in response to a request by the requestor to receive said private version of the personal content, said passcode being assigned to the requestor by the provider before the requestor can receive said private version.

16. The computer-implemented system of claim 15 wherein said processor is also adapted to provide instructions to the provider in setting up said public and private versions of personal content.

17. The computer-implemented system of claim 15 wherein said different versions accepted by said computer-readable memory further include different private versions tailored to different requestors.

18. The computer-implemented system of claim 15 wherein said processor is also adapted to provide plural passcodes associated with each of the different private versions.

19. The computer-implemented system of claim 15 wherein said computer-interfaced device is adapted to display said public and private versions to the requestor.

20. The computer-implemented system of claim 15 wherein said computer-interfaced device is adapted to fax said public and private versions to the requestor.
